(19) United States
(12) Patent Application Publication
(10) Pub. No.: US 2010/0172342 A1
(43) Pub. Date: Jul. 8, 2010

(54) Session Initiation Protocol Message Payload Compression

(76) Inventors: Christer Boberg, Tungelsta (SE); Anders Lindgren, Älvsjö (SE)

Correspondence Address: ERICSSON INC., 6300 LEGACY DRIVE, M/S EVR 1-C-11, PLANO, TX, 75024, US

(21) Appl. No.: 12/298,929

(22) PCT Filed: Oct. 31, 2007
(86) PCT No.: PCT/EP2007/061758

§ 371 Date: Oct. 29, 2008

(51) Int. Cl. H04L 12/66

(52) U.S. Cl. 370/352

(57) ABSTRACT

A method, user terminal, and Session Initiation Protocol (SIP) Application Server for transporting SIP messages across an IP Multimedia network between the user terminal and the SIP Application Server. The sending side compresses message payloads within the application layer and the receiving side decompresses them at the application layer. The compressed message payloads are passed between the application layer and a SIP User Agent via an appropriate Application Programming Interface (API).

### TECHNICAL FIELD

The present invention relates to the compression of the payloads of Session Initiation Protocol messages.

### BACKGROUND

IP Multimedia services provide a dynamic combination of voice, video, messaging, data, etc. within the same session. By growing the number of basic applications and the media which it is possible to combine, the number of services offered to the end subscribers will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) and EMI TISPAN group to provide IP Multimedia services over mobile communication networks (3GPP TS 22.228, TS 23.228, TS 24.229, TS 29.228, TS 29.229, TS 29.328 and TS 29.329 Releases 5 to 7, and TS24.173 Release 7). IMS provides key features to enrich the end-subscriber person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between subscriber terminals (or subscriber terminals and application servers). The Session Description Protocol (SDP), carried by SIP signalling, is used to describe and negotiate the media components of the session. Whilst SIP was created as a subscriber-to-subscriber protocol, IMS allows operators and service providers to control subscriber access to services and to charge subscribers accordingly.

By way of example, FIG. 1 illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the subscriber that the subscriber is subscribed to; and the Interrogating CSCF (I-CSCF) whose role is to identify the correct S-CSCF and to forward to that S-CSCF a request received from a SIP terminal via a P-CSCF.

Within the IMS service network, Application Servers (ASs) are provided for implementing IMS service functionality. Application Servers provide services to end users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a subscriber's Subscriber Profile.

An example IMS service that is facilitated by the use of ASs is that of “presence”. A presence service allows users to disseminate their current availability and location to others, and involves the use of a presence AS within the IMS. A user updates his/her presence status with the presence AS, using the SIP PUBLISH method, and the presence AS then issues SIP NOTIFY messages to peer users who have subscribed to that user' presence. Subscription involves a user sending a SIP SUBSCRIBE message to the presence AS, identifying the user whose presence is being subscribed to. In order to reduce the volume of presence related traffic flowing in the IMS network, a so-called Resource List Server (RLS) AS may be introduced. The RLS acts as a “concentrator” for NOTIFY messages directed to a given user, buffering NOTIFY messages received over some predefined time period, and sending only a single combined NOTIFY message to the subscribing user at the end of that period. The RLS AS also acts as a “middleman” for SUBSCRIBE messages received from a user.

It is appreciated that NOTIFY messages can be very large, with payloads exceeding 64 kbytes. Other SIP messages can be equally large. As such, it is desirable to be able to compress messages to reduce network load. Moreover, compression of messages can improve the overall latency since large messages sent over the air interface (and in the network) may have to be split into several smaller messages.

WO2006/030277 describes a method and apparatus for compressing SIP protocol messages based upon a technique known as SIGCOMP (IEEE RFCs 3320 and 3321). The approach described involves examining message type and content and selectively compressing all or parts of the header and payload in order to leave those message components which must be readable by intermediate network nodes in clear text.

SIGCOMP itself includes both static and dynamic libraries and, within the IMS, is implemented in the IMS terminal and in the P-CSCF. The static library contains pre-defined entries for compressing and decompressing specific messages and message parts. This has two limitations. Firstly, the amount of compression/translation information that the static library can contain may be limited in the end-user terminal due to available memory. Secondly, adding new compression entities to the static library requires changes both the client and the server side. The dynamic library makes use of previous messages to compress and decompress messages. Whilst the use of a dynamic library will achieve a good compression ratio where messages including similar data, if the data changes a lot from message to message, which it will in a multi-service environment, the compression ratio will be low.

Regardless of the compression ratios achieved by SIGCOMP based approaches, SIGCOMP is not yet widely deployed (and static libraries will require ongoing standardisation) and as such there will exist for some time to come a large number of terminals that do not have the latest SIGCOMP support or no SIGCOMP support at all. If for example an IMS presence application is developed for such legacy equipment, the associated SIP message must be transported uncompressed. This problem is also applicable for other types of SIP notifications, e.g. notifications done using the XCAP change event package.

### SUMMARY

According to a first aspect of the present invention there is provided a method of transporting Session Initiation Protocol messages across an IP Multimedia network between a user terminal and a Session Initiation Protocol Application Server. The method comprises compressing message payloads within the application layer at the sending side and decompressing them at the application layer on the receiving side, compressed message payloads being passed between the application layer and a Session Initiation Protocol User Agent via an appropriate Application Programming Interface.

By facilitating payload compression and decompression outside of the SIP User Agent, embodiments of the present invention can be implemented with user terminals that do not have the latest SIP protocols installed, e.g. SIGCOMP compatibility is not required.

According to a preferred embodiment of the invention, the SIP message headers are sent uncompressed so that the messages can be routed through any intermediate CSCFs and Application Servers without requiring decompression and recompression at these nodes.

It is desirable to make use of a well known and readily available algorithm for compressing and decompressing payloads. For example, the gzip algorithm (an abbreviation of GNU zip) may be used.

In the case, for example, of a presence service implemented over the IMS, it is preferable to include in a SIP SUBSCRIBE message sent from the user terminal to a Session Initiation Protocol Application Server, an indication that payload compression is to be performed at the Application Server. The payloads of SIP NOTIFY messages subsequently sent from the Application Server to the user terminal, and relating to the subscriber event, are compressed. Preferably, said indication is included in the Accept or Accept-Encoding header field of the SUBSCRIBE message. More preferably still, the method comprises writing the Accept or Accept-Encoding header field to the Session Initiation Protocol User Agent from said application layer via said Application Programming Interface. In the case of a presence service, the method may comprise including in a SIP PUBLISH message sent from the user terminal to a Session Initiation Protocol Application Server an indication that the message payload is compressed, e.g. in the Content-Type header field. Of course, these procedures may be employed in IMS services other than presence.

In the case of a presence service, said Session Initiation Protocol Application Server may be a Resource List Server.

According to a second aspect of the present invention there is provided a user terminal configured to operate within an IP Multimedia Subsystem service network. The user terminal implements one or more application layers communicating with a Session Initiation Protocol User Agent, the application layer or layers communicating with the Session Initiation Protocol via an Application Programming Interface, the user terminal being further configured to compress and decompress the payloads of outgoing and incoming SIP messages at the application layer or layers and to exchange the compressed payloads with the Session Initiation Protocol User Agent via said Application Programming Interface.

According to a third aspect of the present invention there is provided a Session Initiation Protocol Application Server configured to operate within an IP Multimedia Subsystem service network. The Application Server implements one or more application layers communicating with a Session Initiation Protocol User Agent, the application layer or layers communicating with the Session Initiation Protocol via an Application Programming Interface, the Application Server being further configured to compress and decompress the payloads of outgoing and incoming SIP messages at the application layer or layers and to exchange the compressed payloads with the Session Initiation Protocol User Agent via said Application Programming Interface.

### BRIEF DESCRIPTION OF THE DRAWINGS

FIG. 1 illustrates schematically the integration of an IP Multimedia Subsystem into a 3G mobile communications system;

FIG. 2 illustrates schematically a functional architecture for implementing compression of SIP messages within the IMS; and

FIG. 3 is a flow diagram illustrating a procedure for compressing SIP messages.

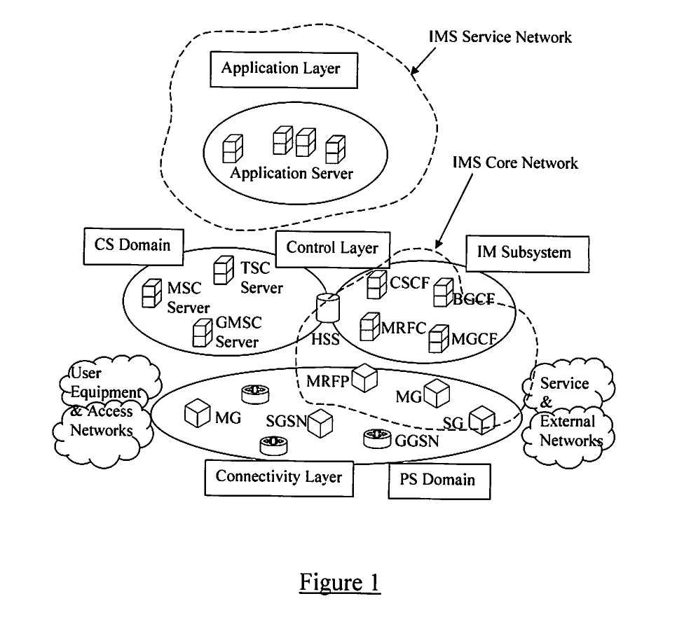

### DETAILED DESCRIPTION

As has already been discussed, a number of different SIP messages used within the IP Multimedia Subsystem (IMS) may include a very large amount of payload data. Such messages include for example SIP Notifications (e.g. for presence, RLS and XCAP changes) and SIP Publications (e.g. for presence). It would be beneficial to use a compression mechanism to reduce the size of the message, particularly to optimise usage of the air interface bandwidth.

Moreover, in order to allow compression to be used with legacy terminals that do not utilise SIGCOMP (or at least SIGCOMP with the latest static compression libraries), it is desirable to facilitate compression at the application layer, above the SIP layer.

It is proposed here to introduce a compression/decompression procedure at the application layer for compressing/decompressing only the payloads of messages and which makes use of a commonly used compression algorithm such as “gzip”. Gzip is based upon the DEFLATE algorithm, which is a combination of LZ77 and Huffman coding. As an alternative to gzip, the well known zip compression format may be used.

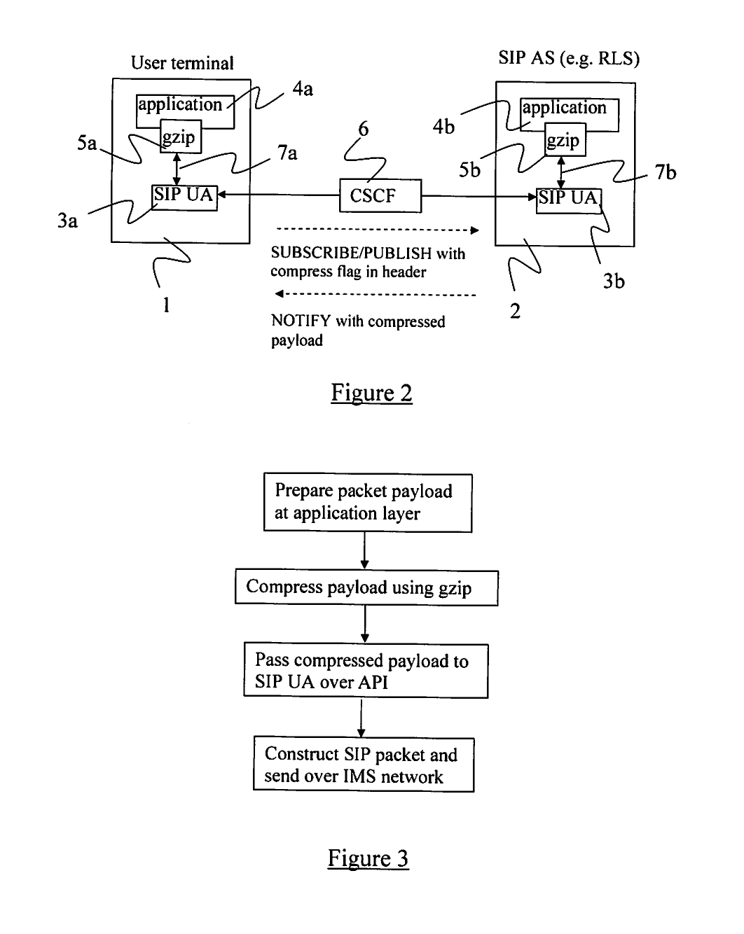

Compression is not performed on the SIP message headers and, as such, any SIP proxy through which a message passes will not be affected since the actual SIP information is not compressed. This is illustrated in FIG. 2, where the user terminal is indicated by reference numeral 1, the (presence) AS or RLS by reference numeral 2, the respective SIP UAs by 3a,3b, and the respective application layers by 4a,4b. The gzip functions are indicated by reference numerals 5a,5b. An exemplary CSCF is indicated by reference numeral 6.

At least in some embodiments of the present invention, the compression/decompression processes are completely transparent to the SIP User Agents (at either the user terminal or the SIP Application Server). The relevant application merely exchanges payload data with the SIP UA via the appropriate SIP UA Application Programming Interface (API), and the SIP UA does not care if the data is compressed or not. [Respective APIs are indicated in FIG. 2 by reference numerals 7a,7b.] This procedure is illustrated in the flow diagram of FIG. 3. However, in other embodiments it may be desirable to allow a user terminal to indicate, for example, in an initial SIP SUBSCRIBE message, that it supports a compressed payload in SIP NOTIFY messages. This could be done for example by allowing the application to write an appropriate statement into the SIP message header. For example, the existing “Accept” or “Accept-Encoding” header fields could be used for this purpose, or a new SIP header field may be specified. Assuming that the notifier (e.g. presence AS) also supports compression it will compress the payloads of all SIP NOTIFY messages sent to the subscriber and relating to the event subscribed to. An indication that a payload is compressed may be contained within the message header, e.g. using the “Content-Type” header field, of the PUBLISH and NOTIFY messages.

Compression may be employed in particular at a Resource List Server (RLS) as the payload sent from an RLS towards the user terminals often contains a large amount of data that is the same syntax and for which compression, using for example gzip, will be very efficient.

It will be appreciated by the person of skill in the art that various modifications may be made to the above described embodiment without departing from the scope of the present invention. For example, it is possible to additionally implement compression/decompression of SIP message headers within the SIP layer. However, this could be optional, dependent upon the SIP protocol version implemented at the client terminal (or SIP AS) and in any case may be undesirable as it may restrict the ability of SIP messages to pass through intermediate nodes without additional processing.

1-14. (canceled)

15. A method of transporting Session Initiation Protocol (SIP) messages across an IP Multimedia Subsystem (IMS) network between a sending side and a receiving side, the method comprising the steps of:
compressing a message payload within an application layer at the sending side;
passing the compressed message payload between the application layer and a SIP User Agent via an appropriate Application Programming Interface (API);
transporting the compressed message payload over the IMS network to the receiving side; and
decompressing the message payload at the application layer on the receiving side.

16. The method according to claim 15, further comprising sending message headers uncompressed so that the messages can be routed through any intermediate Call Session Control Functions (CSCFs) and Application Servers.

17. The method according to claim 15, wherein the compressing and decompressing steps are performed using the GNU zip (gzip) compression utility.

18. The method according to claim 15, wherein the sending and receiving sides are a user terminal and a SIP Application Server, or vice versa.

19. The method according to claim 18, wherein the SIP Application Server is a Resource List Server.

20. The method according to claim 18, further comprising including in a SIP PUBLISH message sent from the user terminal to the SIP Application Server, an indication that the message payload is compressed.

21. The method according to claim 20, wherein the indication is included in the “Content-Type” header field of the SIP PUBLISH message.

22. The method according to claim 21, wherein the step of passing the compressed message payload between the application layer and the SIP User Agent includes writing the Content-Type header field to the SIP User Agent from the application layer via the API.

23. The method according to claim 20, wherein the SIP PUBLISH message relates to a presence service.

24. The method according to claim 15, further comprising the steps of:
including in a SIP SUBSCRIBE message sent from the user terminal to the SIP Application Server, an indication that payload compression is to be performed by the Application Server; and
subsequently compressing the payloads of SIP NOTIFY messages sent from the SIP Application Server to the user terminal.

25. The method according to claim 24, wherein the indication is included in an Accept or Accept-Encoding header field of the SIP SUBSCRIBE message.

26. The method according to claim 25, wherein the step of passing the compressed message payload between the application layer and the SIP User Agent includes writing the Accept or Accept-Encoding header field to the SIP User Agent from the application layer via the API.

27. The method according to claim 24, wherein the SIP SUBSCRIBE and SIP NOTIFY messages relate to a presence service.

28. A user terminal operating within an IP Multimedia Subsystem (IMS) service network, the user terminal comprising:
at least one application layer, said application layer including means for compressing and decompressing the payloads of outgoing and incoming SIP messages, respectively;
a Session Initiation Protocol (SIP) User Agent communicating with the application layer via an Application Programming Interface (API); and
means for exchanging the compressed payloads between the application layer and the SIP User Agent via the API.

29. A Session Initiation Protocol (SIP) Application Server operating within an IP Multimedia Subsystem (IMS) service network, the SIP Application Server comprising:
at least one application layer, said application layer including means for compressing and decompressing the payloads of outgoing and incoming SIP messages, respectively;
a Session Initiation Protocol (SIP) User Agent communicating with the application layer via an Application Programming Interface (API); and
means for exchanging the compressed payloads between the application layer and the SIP User Agent via the API.

30. A method of transporting Session Initiation Protocol (SIP) messages across an IP Multimedia network between a user terminal and a SIP Application Server, the method comprising the steps of:
receiving at the SIP Application server, a SIP SUBSCRIBE message sent from the user terminal to the SIP Application Server, the SIP SUBSCRIBE message including an indication that payload compression is to be performed at the SIP Application Server, said indication being included in the Accept or Accept-Encoding header field of the SIP SUBSCRIBE message; and
in response to receiving the indication by the SIP Application Server, subsequently compressing the payloads of SIP NOTIFY messages sent from the SIP Application Server to the user terminal.
